(19) United States
(12) Patent Application Publication
(10) Pub. No.: US 2018/0105350 A1
(43) Pub. Date: Apr. 19, 2018

(54) APPARATUS FOR TRANSPORTING REAL-ESTATE SIGNS AND METHOD

(71) Applicant: Gregory Weik, Centennial, CO (US)

(72) Inventor: Gregory Weik, Centennial, CO (US)

(21) Appl. No.: 15/786,385

(22) Filed: Oct. 17, 2017

Related U.S. Application Data
(60) Provisional application No. 62/409,349, filed on Oct. 17, 2016.

(51) Int. Cl. B65D 85/00; A45C 11/00

(52) U.S. Cl. CPC B65D 85/00; B60R 9/065; A45C 11/00

(57) ABSTRACT

An apparatus includes a container having a plurality of legs, a plurality of shelves, a first side-door, a second side-door, and a plurality of shelf supports. The apparatus is useful for safely transporting and storing real-estate signs from location to location.

### CROSS-REFERENCE TO RELATED APPLICATION(S)

The present application is related to and claims priority to U.S. Provisional Patent Application No. 62/409,349 filed Oct. 17, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of containers of existing art and more specifically relates to containers for real-estate signs.

### Related Art

Realtors have consistently had problems transporting real-estate signs from location to location. Real-estate signs provide content to promote properties. Real-estate signs for the present disclosure may be of any size that is no more than approximately 20 inches in width and 45 inches in length. Generally, realtors will use the trunk of their personal car, or the rear compartment of their personal SUV, mini-van, etc. to transport real-estate signs to a particular location. In doing so, the real-estate sign may become damaged and create loud noises from the motions of a moving vehicle. Additionally, the real-estate signs may damage the vehicle in the process. Therefore, a suitable solution is desired.

U.S. Pat. No. 8,403,192 to Kenneth S. Roller, et al. relates to a vehicle-mounted real estate sign carrier assembly and associated method. The described vehicle-mounted real estate sign carrier assembly and associated method includes vehicle-mounted real estate sign carrier assembly includes a U-shaped rack having front, back and side walls, and an L-shaped support rail. The support rail may be adapted to directly connect to a vehicle trailer hitch and locked with a pin when in use. A flexible strap directly mated to a top end of the support rail wraps about each of the stakes such that the real estate signs remain vertically stacked while the display screens are seated within the rack in a stable manner. The carrier assembly may transport multiple real estate signs to various locations, safely and easily by providing a quick-assembly, sturdy, compact and stable construction. Constructed with a low center of gravity the assembly allows a user to travel over bumpy and winding roads without the risk of dislodging his real estate signs from his vehicle.

### SUMMARY OF THE INVENTION

In view of the foregoing disadvantages inherent in the known real-estate container art, the present disclosure provides a novel apparatus for transporting real-estate signs and method. The general purpose of the present disclosure, which will be described subsequently in greater detail, is to provide an apparatus for transporting real-estate signs and method.

An apparatus for transporting real-estate signs is disclosed herein. The apparatus includes a container that may include a top opposite a bottom, a left-side opposite a right-side, and a front-side opposite a back-side. The container may define an interior cavity. Furthermore, a plurality of legs may be coupled to the bottom of the container, and configured to support the container at an elevated position above a surface.

A plurality of shelves may extend across the interior cavity from at least one of the left-side to the right-side and the front-side to the back-side, the plurality of shelves configured to support the real-estate signs, the plurality of shelves may include a plurality of cut-outs configured to provide access to retrieve the real-estate signs from the container.

A first side-door may be pivotably coupled to the bottom of the container, and configured to provide access to the interior cavity in a first open state, and to secure to the top of the container in a first closed state. Furthermore, a second side-door may be pivotably coupled to the bottom of the container, perpendicularly to the first side-door, and configured to provide access to the interior cavity in a second open state, and to secure to the top of the container in a second closed state. Moreover, a plurality of shelf supports may extend from the first-side door and the second-side door, respectively, the plurality of shelf supports may be configured to provide structural support for the plurality of shelves.

According to another embodiment, a method of using the apparatus for transporting real-estate signs and/or storing real-estate signs for transport is also disclosed herein. The method includes opening the first side-door to access the interior cavity of the container, inputting at least one real-estate sign into the interior cavity, closing the first side-door of the container, attaching the container to a vehicle using a plurality of tie-down straps, opening the second side-door to access the interior cavity of the container, removing the at least one real-estate sign, and closing the second side-door of the container.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, an apparatus for transporting real-estate signs and method, constructed and operative according to the teachings of the present disclosure.

FIG. 1 is a perspective view of the apparatus during an ‘in-use’ condition, according to an embodiment of the disclosure.

FIG. 2 is a perspective view of the apparatus of FIG. 1 in an open state, according to an embodiment of the present disclosure.

FIG. 3 is a perspective view of the apparatus of FIG. 1, in a closed state, according to an embodiment of the present disclosure.

FIG. 4 is a front view of the apparatus of FIG. 1, according to an embodiment of the present disclosure.

FIG. 5 is a flow diagram illustrating a method of using the apparatus, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a container for real-estate signs and more particularly to an apparatus for transporting real-estate signs and method as used to improve the transportation and protection of real-estate sign from location to location.

Generally, real-estate signs, when not in use, are commonly stored within a vehicle. These real estate signs typically feature sharp, pointed stakes that cause damage to the vehicle's interior. Additionally, real-estate signs may have excess dirt and debris from being placed outside. When multiple real-estate signs are being transported in the vehicle at once, they can cause loud noises and damage from hitting each other from the motions of the vehicle. The preset disclosure may provide users with a container used for organizing, protecting, and transporting most common sizes of real-estate signs, as discussed above. It can fit in the rear portion of a variety of vehicle types. The container may offer additional space or attachments to carry other common real estate items such as lockboxes, flyers, and the like.

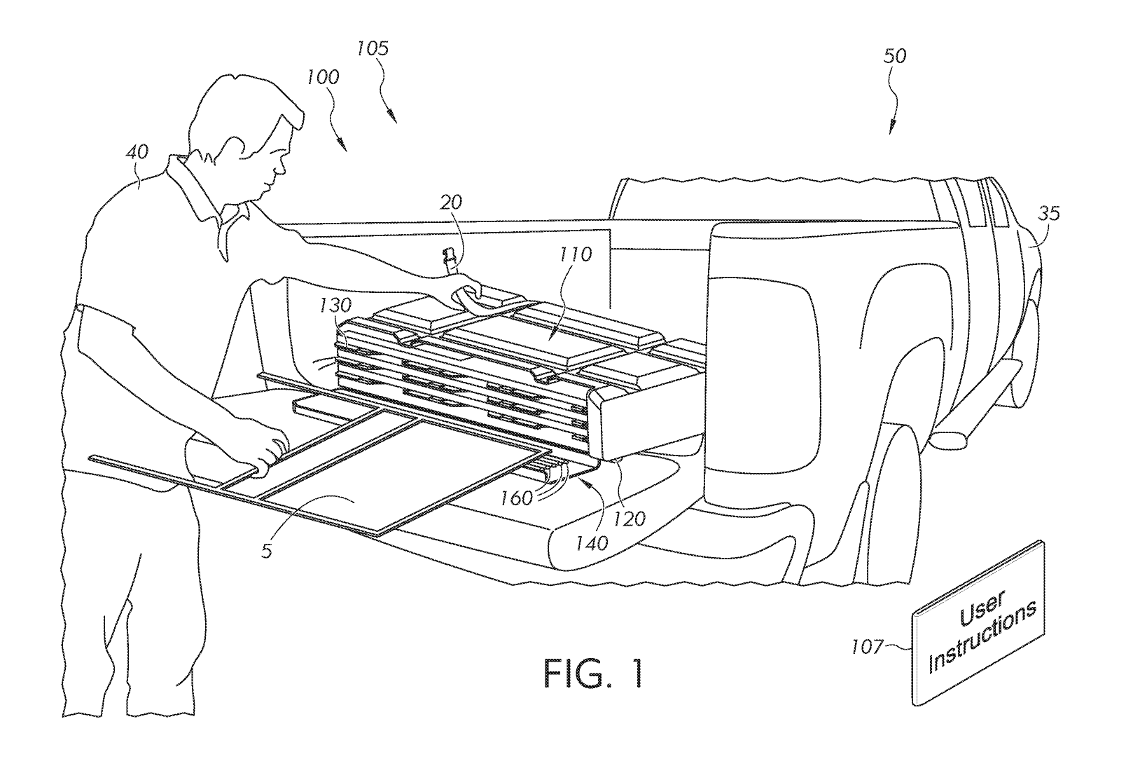

Referring now more specifically to the drawings by numerals of reference, there is shown in FIGS. 1-4, various views of an apparatus for storing/transporting real-estate signs (apparatus 100).

FIG. 1 shows the apparatus 100 during an ‘in-use’ condition 50, according to an embodiment of the present disclosure. Here, the apparatus 100 may be beneficial for use by a user 40 to transport real-estate signs 5 on a vehicle 35 or other means of transportation. As illustrated, the apparatus 100 may include a container 110, a plurality of legs 120, a plurality of shelves 130, a first side-door 140, and a second side-door 150. Further, the first side-door 140 may be mounted perpendicularly (adjacent to) and the second side-door 150, as shown. According to one embodiment, the apparatus 100 may also include a plurality of shelf supports 160 fixed to at least one of the first side-door 140 and the second side-door 150.

It should be understood that orientation terms such as left/right, front/back, and top/bottom are merely used for clarity and convenience, but are not limiting, as it is contemplated that the apparatus 100 may be affixed to or carried within the vehicle 35 (FIG. 1) in a myriad of orientations. Further, it should be understood, the first side-door 140 and the second side-door 150 are described as “side” doors relative to the container 110, and not necessarily relative to the vehicle 35.

According to one embodiment, the apparatus 100 may be arranged as a kit 105. In particular, the apparatus 100 may further include a set of instructions 107. The instructions 107 (not shown) may detail functional relationships in relation to the structure of the apparatus 100 such that the apparatus 100 can be used, maintained, or the like, in a preferred manner.

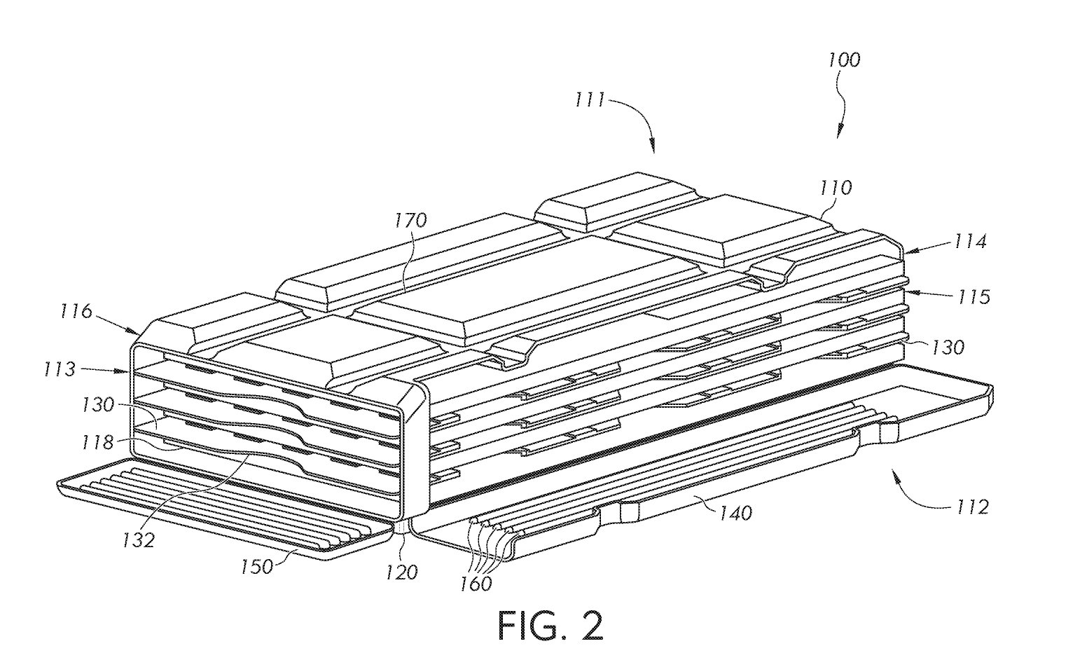

FIG. 2 shows the apparatus 100 of FIG. 1 in an open state, according to an embodiment of the present disclosure. As above, the apparatus 100 may include the container 110, the plurality of legs 120, the plurality of shelves 130, the first side-door 140, the second side-door 150, and the plurality of shelf supports 160. Here, the apparatus for storing/transporting real-estate signs 100 is shown in an “open” state, where real-estate signs can be inserted from either side associated with the first side-door 140, and the second side-door 150. It should be understood that the “open state” may include one or more side-doors being open.

As shown, the container 110 may have a bottom 112, a top 111 opposite the bottom 112, a left-side 114, a right-side 113 opposite the left-side 114, a back-side 116, and a front-side 115 opposite the back-side 116. The container 110 may define the interior cavity 118. Furthermore, the plurality of legs 120 may be coupled to the bottom 112 of the container 110,

The plurality of shelves 130 may extend across the interior cavity 118 from at least one of the right-side 113 to the left-side 114 and the front-side 115 to the back-side 116, the plurality of shelves 130 may be configured to support the real-estate signs 5 (FIG. 1). The plurality of shelves 130 may include the plurality of cut-outs 132 configured to provide access to retrieve the real-estate signs 5 from the container 110 (e.g., where fingers may grab a leading edge of one real-estate sign 5 without interference from its respective shelf).

The plurality of shelves 130 may include the plurality of cut-outs 132 that are positioned proximate the first side-door 140 or proximate the second side-door 150, respectively. The plurality of shelves 130 may include at least three shelves. Moreover, the plurality of shelves 130 may be removable from the container 110. The plurality of shelves 130 may be composed of a sound dampening material. With such a feature, sounds from the real-estate signs 5 may not be heard by the user 40 during transportation.

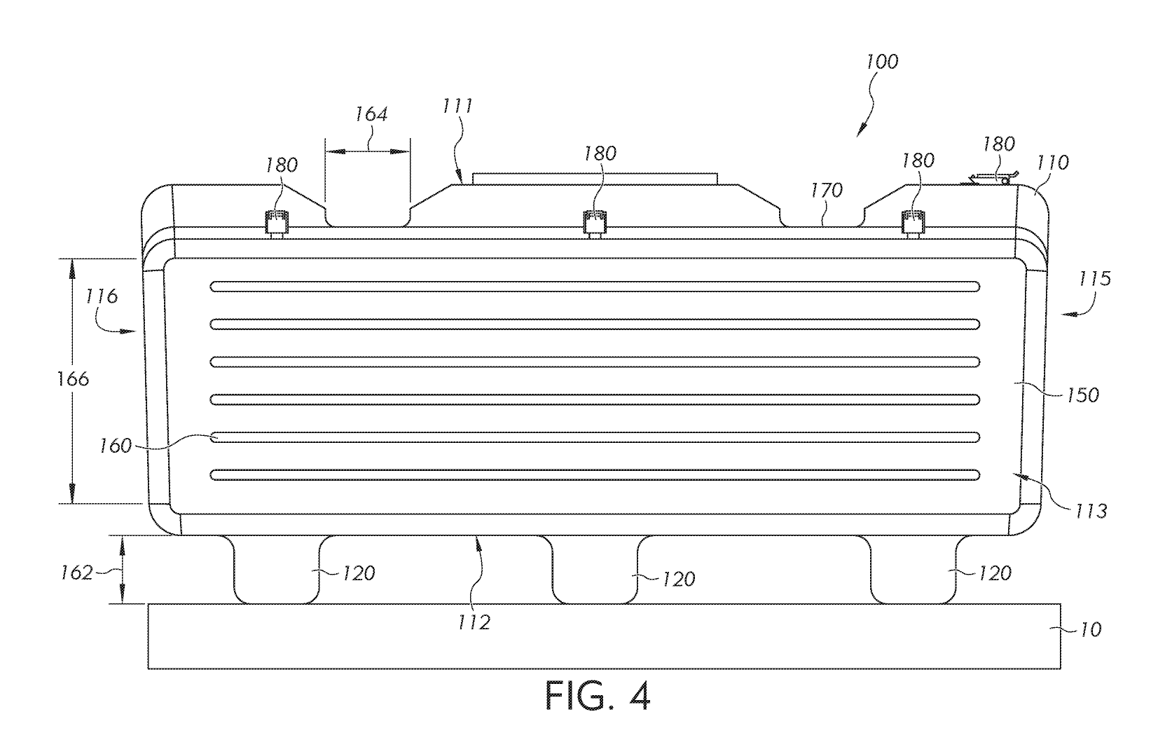

As shown, the first side-door 140 may be pivotably coupled to the bottom 112 of the container 110. The first side-door 140 may be configured to provide access to the interior cavity 118 when in an open state, and further configured to secure to the top 111 of the container 110 when in a closed state (FIG. 4).Similarly, the second side-door 150 may be pivotably coupled to the bottom 112 of the container 110, perpendicularly to the first side-door 140. The second side-door 150 may be configured to provide access to the interior cavity 118 when in the open state, and further configured to secure to the top 111 of the container 110 when in the closed state. The second side-door 150 may be smaller than the first side-door 140 (e.g., corresponding to a rectangular shape of the overall container from a top view).

As shown, the plurality of shelf supports 160 may extend from the first-side door 140 and the second-side door 150, respectively, the plurality of shelf supports 160 may be configured to provide structural support for the plurality of shelves 130.

According to one embodiment, at least one of the top 111 and the bottom 112 of the container 110 may be substantially rectangular. Furthermore, the at least one of the top 111 and the bottom 112 of the container 110 may have first rectangular dimension of at least 20 inches and a second rectangular dimension of at least 45 inches. Such dimensions may allow for storage of a standard sized real-estate sign 5.

According to one embodiment, the top 111 of the container 110 may further include a plurality of corrugations 170 that extend orthogonally across the top 111 of the container 110. The plurality of corrugations 170 may be alternately viewed as the top 111 of the container 110 having a plurality of channels molded into the top 111 as pathways for a strap to tie down and secure the container 110 to as surface, such as an automobile rooftop. According to one embodiment, the plurality of corrugations 170 may include at least two lateral corrugations and two longitudinal corrugations. A plurality of tie-down straps 20 (FIG. 1) may be utilized with the container 110, each tie-down strap 20 having a strap thickness and a strap width. As such, the plurality of corrugations 170 may have a pitch 164 of at least the strap width. As used here, “pitch” should be understood to indicate the channel width (see e.g., FIG. 4). According to one embodiment, the pitch 164 may be at least 0.5 inch.

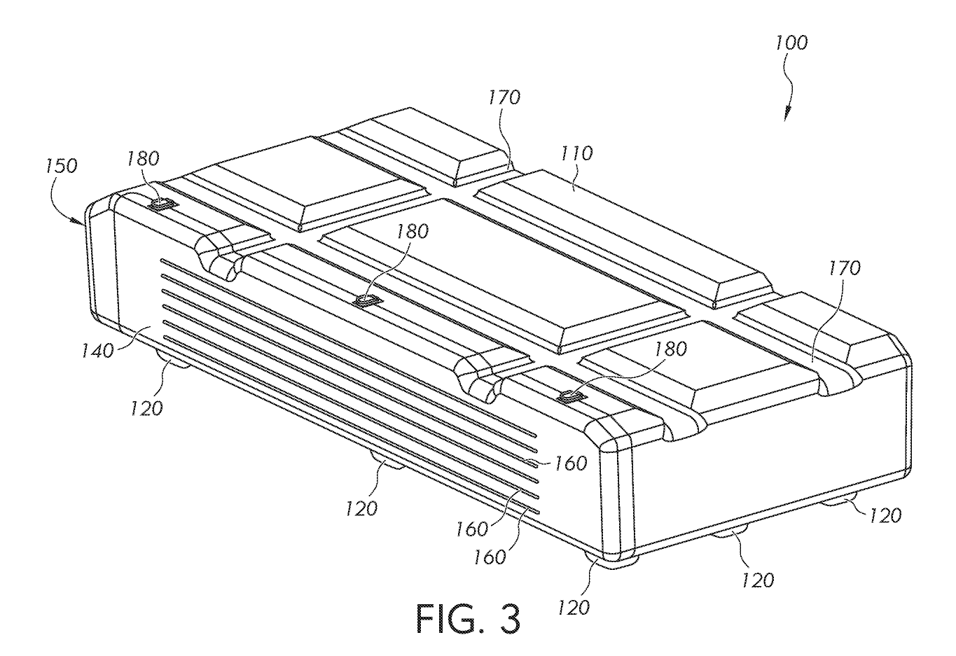

FIG. 3 is a perspective view of the apparatus 100 of FIG. 1 in a closed state, according to an embodiment of the present disclosure. It should be understood that the “closed state” with regard to the entire apparatus 100 may indicate all side-doors being closed, and with regard to an individual side-door, may include the respective side-door being closed. As above, the container 110 may include the first side-door 140 and the second side-door 150, each may include a plurality of latches 180 configured to secure the first side-door 140 in the first closed state and the second side-door 150 in the second closed state), respectively.

FIG. 4 is a front view of the apparatus 100 of FIG. 1, according to an embodiment of the present disclosure. The container 110 may include the plurality of legs 120 coupled to the bottom 112 of the container 110, and configured to support the container 110 at the elevated position 162 above the surface 10 (for example, a rooftop of the vehicle 35). The elevated position 162 above the surface 10 may be sized and dimensioned to be sufficient to enable or provide for the first side-door 140 and the second side-door 150 to be opened outwardly and downward to at least a horizontal orientation (e.g., parallel with rooftop of the vehicle 35). According to one embodiment, the elevated position 162 above the surface 10 may be between one inch and four inches above the surface 10.

Upon reading this specification, it should be appreciated that, under appropriate circumstances, considering such issues as user preferences, design preference, structural requirements, marketing preferences, cost, available materials, technological advances, etc., other shape arrangements for the container 110 such as, for example, square, etc., may be sufficient for different sized real-estate signs.

According to another embodiment, the top 111 and the bottom 112 of the container 110 may be configured with a cavity height 166 (e.g., normal separation of the top 111 and the bottom 112 of the container 110) sufficient for multiple real-estate sign to be stowed into the interior cavity 118. For example, the top 111 and the bottom 112 of the container 110 may be separated by at least eight inches.

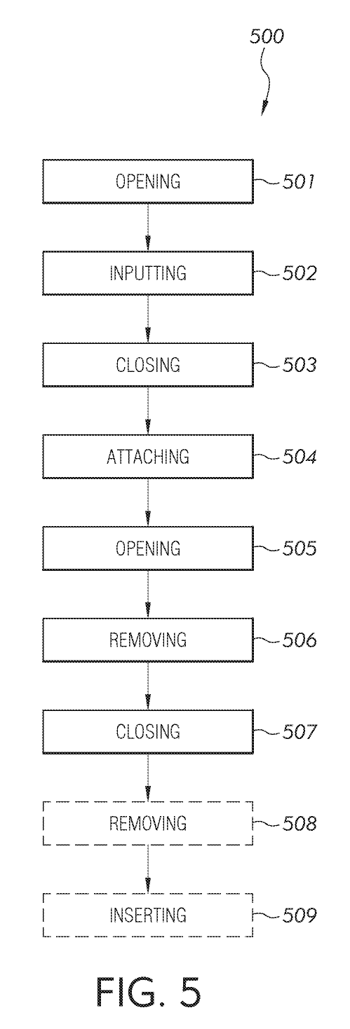

FIG. 5 is a flow diagram illustrating a method for using an apparatus 500, according to an embodiment of the present disclosure. In particular, the method for using the apparatus 500 may include one or more components or features of the apparatus 100 as described above. As illustrated, the method for using the apparatus 500 may include the steps of: step one 501, opening the first side-door to access the interior cavity of the container; step two 502, inputting at least one real-estate sign into the interior cavity; step three 503, closing the first side-door of the container; step four 504, attaching the container to the vehicle using the plurality of tie-down straps; step five 505, opening the second side-door to access the interior cavity of the container; step six 506, removing the at least one real-estate sign; step seven 507, closing the second side-door of the container. According to one embodiment, the method for using the apparatus 500 may further include the steps of step eight 508, removing at least one of the plurality of shelves from the interior cavity of the container; and step nine 509, inserting an item (not shown) in the interior cavity of the container, said item being larger than an available portion of the interior cavity of the container while the removed at least one of the plurality of shelves is installed.

It should be noted that step eight 508 and step nine 509 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for the apparatus 100 (e.g. different step orders within above-mentioned list, and elimination or addition of certain steps) are taught herein. [39] The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An apparatus for transporting real-estate signs, the apparatus comprising:
a container including a bottom, a top opposite the bottom, a right-side, a left-side opposite the right-side, a back-side, and a front-side opposite the back-side, the container defining an interior cavity;
a plurality of legs coupled to the bottom of the container, and configured to support the container at an elevated position above a surface;
a plurality of shelves extending across the interior cavity from at least one of the left-side to the right-side and the front-side to the back-side, the plurality of shelves configured to support the real-estate signs, the plurality of shelves including a plurality of cut-outs configured to provide access to retrieve the real-estate signs from the container
a first side-door pivotably coupled to the bottom of the container and configured to provide access to the interior cavity in a first open state, and to secure to the top of the container in a first closed state;
a second side-door pivotably coupled to the bottom of the container, perpendicularly to the first side-door, and configured to provide access to the interior cavity in a second open state, and to secure to the top of the container in a second closed state; and
a plurality of shelf supports extending from the first-side door and the second-side door, respectively, the plurality of shelf supports configured to provide structural support for the plurality of shelves.

2. The apparatus of claim 1, wherein at least one of the top and the bottom of the container is substantially rectangular.

3. The apparatus of claim 2, wherein the at least one of the top and the bottom of the container has first rectangular dimension of at least 20 inches and has second rectangular dimension of at least 45 inches.

4. The apparatus of claim 1, wherein the elevated position above the surface is sufficient to enable the first side-door and the second side-door to be opened outwardly to at least a horizontal orientation.

5. The apparatus of claim 4, wherein the elevated position above the surface is between one inch and four inches above the surface.

6. The apparatus of claim 1, wherein the top and the bottom of the container are separated by at least eight inches.

7. The apparatus of claim 1, wherein the second side-door is smaller than the first side-door.

8. The apparatus of claim 1, wherein the top of the container includes a plurality of corrugations extending orthogonally across the top of the container.

9. The apparatus of claim 8, wherein the plurality of corrugations includes at least two lateral corrugations and two longitudinal corrugations.

10. The apparatus of claim 8, further including a plurality of tie-down straps, each tie-down strap having a strap thickness and a strap width; and
wherein the plurality of corrugations have a pitch of at least the strap width.

11. The apparatus of claim 9, wherein the pitch is at least 0.5 inch.

12. The apparatus of claim 1, wherein the plurality of cut-outs of the plurality of shelves are positioned proximate the first side-door or proximate the second side-door, respectively.

13. The apparatus of claim 1, wherein the plurality of shelves includes at least three shelves.

14. The apparatus of claim 1, wherein the plurality of shelves are removable from the container.

15. The apparatus of claim 1, wherein the plurality of shelves are composed of a sound dampening material.

16. The apparatus of claim 1, wherein the first side-door and the second side-door each include a plurality of latches configured to secure the first side-door in the first closed state and the second side-door in the second closed state, respectively.

17. An apparatus for transporting real-estate signs, the apparatus comprising:
a container including a bottom, a top opposite the bottom, a right-side, a left-side opposite the right-side, a back-side, and a front-side opposite the back-side , the container defining an interior cavity;
a plurality of legs coupled to the bottom of the container, and configured to support the container at an elevated position above a surface;
a plurality of shelves extending across the interior cavity from at least one of the left-side to the right-side and the front-side to the back-side, the plurality of shelves configured to support the real-estate signs, the plurality of shelves including a plurality of cut-outs configured to provide access to retrieve the real-estate signs from the container;
a first side-door pivotably coupled to the bottom of the container and configured to provide access to the interior cavity in a first open state, and to secure to the top of the container in a first closed state;
a second side-door pivotably coupled to the bottom of the container, perpendicularly to the first side-door, and configured to provide access to the interior cavity in a second open state, and to secure to the top of the container in a second closed state;
a plurality of shelf supports extending from the first-side door and the second-side door, respectively, the plurality of shelf supports configured to provide structural support for the plurality of shelves; and
a plurality of tie-down straps, each tie-down strap having a strap thickness and a strap width; and
wherein at least one of the top and the bottom of the container is substantially rectangular;
wherein the at least one of the top and the bottom of the container has first rectangular dimension of at least 20 inches and has second rectangular dimension of at least 45 inches;
wherein the elevated position above the surface is sufficient to allow the first side-door and the second side-door to be opened outwardly to at least a horizontal orientation;
wherein the elevated position above the surface is between one inch and four inches above the surface;
wherein the top and the bottom of the container are separated by at least eight inches;
wherein the second side-door is smaller than the first side-door;
wherein the top of the container includes a plurality of corrugations extending orthogonally across the top of the container;
wherein the plurality of corrugations includes at least two lateral corrugations and two longitudinal corrugations;
wherein the plurality of corrugations have a pitch of at least the strap width;
wherein the pitch is at least 0.5 inch;
wherein the plurality of cut-outs of the plurality of shelves are positioned proximate the first side-door or proximate the second side-door, respectively;
wherein the plurality of shelves includes at least three shelves;
wherein the plurality of shelves are removable from the container;
wherein the plurality of shelves are composed of a sound dampening material; and
wherein the first side-door and the second side-door each include a plurality of latches configured to secure the first side-door in the first closed state and the second side-door in the second closed state, respectively.

18. The apparatus of claim 17, further comprising set of instructions; and
wherein the apparatus is arranged as a kit.

19. A method of storing real-estate signs for transport, the method comprising the steps of:
opening a first side-door to access an interior cavity of a container;
inputting at least one real-estate sign into the interior cavity;
closing the first side-door of the container;
attaching the container to a vehicle using a plurality of tie-down straps;
opening the second side-door to access the interior cavity of the container;
removing the at least one real-estate sign; and
closing the second side-door of the container.

20. The method of claim 19, further comprising the steps of
removing at least one of a plurality of shelves from the interior cavity of the container; and
inserting an item in the interior cavity of the container, said item being larger than an available portion of the interior cavity of the container while the removed at least one of the plurality of shelves is installed.
